(19) United States
(12) Patent Application Publication
(10) Pub. No.: US 2024/0380202 A1
(43) Pub. Date: Nov. 14, 2024

(54) METHOD FOR A STATE ESTIMATION OF AN ELECTRICAL ENERGY DISTRIBUTION NETWORK, STATE ESTIMATION ARRANGEMENT AND COMPUTER PROGRAM PRODUCT

(71) Applicant: Siemens Aktiengesellschaft, München (DE)

(72) Inventor: Sylwia Henselmeyer, Erlangen (DE)

(21) Appl. No.: 18/661,940

(22) Filed: May 13, 2024

(30) Foreign Application Priority Data
May 11, 2023 (EP) 23172782.7

(51) Int. Cl. H02J 3/00

(52) U.S. Cl. CPC H02J 3/003; H02J 2203/10; H02J 2203/20

(57) ABSTRACT

A method for state estimation of an electrical energy distribution network uses a load flow calculation device based on a network model taking into account nodes, switching devices and measurement locations, for load states and switching states of the switching devices, to perform load flow calculations and store load flow results in a load flow data set. The load flow data set for each node in the network model provides a probability distribution for values of a first electrical variable. A state estimation including voltage values at the nodes is determined for the distribution network using a state estimation device. A hidden Markov model determines a most probable value for a second electrical variable for each node, taking into account the load flow data set, present switching states of switching devices and present measurement values at the measurement locations. A corresponding state estimation arrangement and computer program product are provided.

### CROSS-REFERENCE TO RELATED APPLICATION

This application claims the priority, under 35 U.S.C. § 119, of European Patent Application EP23172782.7, filed May 11, 2023; the prior application is herewith incorporated by reference in its entirety.

### FIELD AND BACKGROUND OF THE INVENTION

The invention relates to a method for a state estimation of an electrical energy distribution network, a state estimation arrangement for a state estimation of an electrical energy distribution network, and a computer program product.

The product brochure “Intelligent Control Center Technology-Spectrum Power”, Siemens AG 2017, Article No. EMDG-B90019-00-7600, discloses software for a so-called “Supervisory Control and Data Acquisition (SCADA)” system, i.e. a control center. SCADA systems have been known for a long time for monitoring and controlling energy grids. (See the Wikipedia permanent link at: https://en.wikipedia.org/w/index.php?title=SCADA&oldid=858433181). They involve measurement values from sensors, for example from voltage measuring units and current measuring units in the energy grid, being aggregated and transmitted to the control center. In order to control circuit breakers and isolating switches in the energy grid and to actuate energy generators such as power stations, control commands are sent to the energy grid. Those control commands are received and processed by “remote terminal units” (RTUs), “programmable logic controllers” (PLCs) and “intelligent devices” (IEDs) in order to actuate the circuit breakers and the isolating switches, etc. To date, there has often been provision in the control center for a local computing center on which the control center software, such as, for example, Spectrum Power, runs. Engineers who are able to monitor the displays of the SCADA relating to the present operating state of the energy grid and, in the event of a fault, to take countermeasures, such as, for example, shutting down a grid section, are provided in the control center around the clock. The control center software is generally operated in a central computer arrangement, which may be in the form of a computing center with processors, data memories and screens, for example. The term “central” indicates that all measurement data from the energy grid and all control commands for the energy grid are processed centrally.

The computer arrangement, or the control center software, may also be produced partly or completely as a cloud application, that is to say a server arrangement with locally distributed resources for data processing and data storage that are connected by way of a data network, such as, for example, the Internet.

An accompanying phenomenon of ever wider use of distributed energy generation, that is to say for example by photovoltaic installations or wind power installations, is that the ever more numerous local energy generators supplying to the low-voltage and medium-voltage grid make predicting a system state of the energy grid more difficult. The dependency on weather influences also increases because, for example, solar cells are heavily influenced by clouds and wind power installations by wind strength. These problems also have repercussions for the next-higher voltage level of an energy transmission network at the high-voltage level, which is therefore more difficult to control and to predict.

Until now, load and generation predictions and/or schedules have generally been used in conjunction with a so-called “Distribution System Power Flow (DSPF)” to estimate a future network state. DSPF uses static equipment data, local predictions for energy consumption and energy generation and also dynamic topology information (i.e. which lines are presently connected between the individual components) to calculate a predicted voltage absolute value and voltage angle at each network section. One such approach is known, for example, from the product brochure “Spectrum Power Active Network Management”, Siemens AG 2016, EMFG-B10104-00. The technical principles are known from the publications “Real-Time Distribution System State Estimation” by Dzafic et al., 2010 IEEE 978-I-4244-7398-4 and “Real-Time Estimation of Loads in Radial and Unsymmetrical Three-Phase Distribution Networks” by Dzafic et al., 2013 IEEE 0885-8950.

At present, distribution network operators measure on average approximately 20% of the distribution network nodes. The rest of the distribution network is unobserved. In the low-voltage range, smart meters are increasingly being used but, unlike the measurement values received in control centers, their measurement values are not provided in real time, but rather arrive several hours after the measurement. They are therefore not usable for the calculation of the network state in the medium-voltage range without further processing such as e.g. in predictions.

Nevertheless, the distribution network operators want to be informed when limit value contraventions occur at the unobserved nodes, too. The same applies when the few measurement values available have inconsistencies in relation to one another. The state estimation is used for this purpose.

At the same time, the network operators have network models of good quality, and so load flow methods can be used very successfully and yield reliable results.

Traditional methods for state estimation from the field of transmission networks are difficult to employ in distribution networks due to the lack of measured information at on average 80% of the network nodes. The traditional methods therefore resort to pseudo-measurement values, with the aid of which the load information is modeled. However, these models are very inaccurate and usually require further methods such as e.g. load scaling in order to initialize the load information with the measured values. This method, in particular, requires many case differentiations (depending on available measurement values, the positioning thereof in the network and availability of distributed generation) and is not really accurate per se. However, the convergence behavior and the target reliability of the state estimation at the measurement sites depend on the accuracy of the load scaling.

In addition, traditional state estimation methods and also “Distribution System State Estimation” (DSSE) require the solution of an underdetermined system of equations by using Newton-Raphson. With unsuitable weighting of the measurement values or depending on the choice of state variables (voltages, currents or powers), convergence problems may occur. Loop topology as well appears to be a challenge for these methods if voltages are not chosen as state variables.

Besides the analytical methods, neural networks (in particular “Multi Layer Perceptron Networks”) have recently been employed as well. However, the greatest disadvantages of neural networks are:
Rigid structure (fixed number of inputs and outputs): Each configuration of measurement values and switch positions requires a neural network.
Training data have to be provided for each individual network representing a specific configuration of measurement values and switch positions.
Training has to be carried out for each individual network.
Networks have to be stored and managed.
Networks have to be retrained if the error rate becomes too high.

### SUMMARY OF THE INVENTION

It is accordingly an object of the invention to provide a method for a state estimation of an electrical energy distribution network, a state estimation arrangement and a computer program product, which overcome the hereinafore-mentioned disadvantages of the heretofore-known methods, arrangements and computer program products of this general type and which enable the state of an electrical energy distribution network to be estimated comparatively simply, rapidly and reliably.

With the foregoing and other objects in view there is provided, in accordance with the invention, a method for a state estimation of an electrical energy distribution network, the method comprising using a load flow calculation device on the basis of a network model taking into account nodes and switching devices and measurement locations, for a multiplicity of load states and for a multiplicity of switching states of the switching devices, to carry out load flow calculations and to store the respective load flow result in a load flow data set, the load flow data set for each node in the network model providing a probability distribution for a respective value of at least one first electrical variable, by using a state estimation device, a state estimation that includes the respective voltage values at the nodes is determined for the electrical energy distribution network, and by taking into account the load flow data set and present switching states of switching devices and present measurement values that were detected at the measurement locations, a hidden Markov model is used to determine a most probable value for a second electrical variable for each node.

A state is e.g. a total set of values of electrical variables which are present at various points in the energy distribution network at a predefined time. By way of example, the state includes the voltages (generally as complex numbers) which are present at the network points. The points or measurement points can be e.g. nodes, i.e. end points of a line or a line intersection. Typically, measurement locations for measuring units for electrical voltage, current intensity and optionally phase angle are also provided at such nodes. A state estimation is a computer-calculated estimation of the state, based on available measurement values, i.e. the state or the electrical variables is/are calculated for those nodes which cannot be observed using measuring units.

A network state or a state estimation within the meaning of the invention includes for example an indication about the voltage absolute value or an electrical voltage and the voltage angle or phase angle at each network section. A network section is e.g. also referred to as “network bus” within the meaning of the “bus-branch” model. It functions as a network model connection point to which modeled equipment of the electrical network such as lines, transformers, consumers and generators of electrical energy can be linked.

A device within the meaning of the invention includes, for example, processors, data memories and screens. Devices are e.g. computers such as e.g. servers which include data processor resources and data memory resources and can exchange data with other computers. They can also be software modules executed on a cloud infrastructure, i.e. a spatially distributed server and database architecture.

Measuring devices can be, for example, voltage measuring units, current measuring units, phase measuring units or “phasor measurement units (PMUs)”, “remote terminal units” or intelligent electricity meters or “smart meters”, “intelligent electronic devices (IEDs)” for monitoring switches and other equipment, control devices e.g. for intelligent substations or protective apparatuses which are used at the measurement locations. In this case, the data transmission of the measurement data can be effected e.g. according to the IEC 61850 protocol or according to the Internet Protocol. Data can be transmitted by way of powerline communication via the electrical network, or by way of radio, e.g. by way of LTE (4G), or in a wired manner, such as e.g. Ethernet or optical waveguides.

A network model is e.g. a description of the topology, i.e. the spatial arrangement of equipment such as switching devices, transformers, consumers or loads, etc., and also lines including the operating parameters of the equipment. By way of example, the network model contains information about the spatial arrangement of nodes, switching devices and measurement locations and/or the parameters of the equipment.

Load and generator data are available in the form of Gaussian distributions. These are created e.g. separately for every 15 minutes of the day, of the day of the week and of the season, which corresponds to the present-day standard for the distribution network operators. This yields the load state of the energy network.

The switching states are, for example, an open or closed state for each switching device.

The load flow result is calculated for the example that is to be calculated in each case, i.e. the assumed load state, in a manner that is customary per se using a load flow algorithm. The load flow algorithm is implemented e.g. for different topologies and different times of the day and seasons (for every 15 minutes of the day, of a specific day of the week and/or of a season). Monte-Carlo sampling is used here to simulate different loading scenarios. A large number, e.g. more than 100, even more preferably more than 1000, of different combinations of load states and switching states can be simulated.

The load flow data set is stored e.g. in a data memory of a computer, or in a cloud data memory solution. It generally needs to be calculated beforehand only once and includes for example a few hundred or a few thousand load flow results which arise from different load and switching states. An update can be carried out if the topology of the energy distribution network is changed as a result of new installations of apparatuses, expansion of the network with new lines, etc.

Depending on the multiplicity of load flow results, the probability distribution of the first electrical variable, e.g. voltage, can be calculated for each node. A Gaussian normal distribution can be assumed, for example, the mean value of which corresponds to the most probable case. In other words, a most probable voltage value serving as expected value over the multiplicity of load and switching states arises e.g. for each node.

A hidden Markov model is a mathematical model known for example from Wikipedia (permanent link: https://de.wikipedia.org/w/index.php?title=Hidden_Markov_Model&oldid=224921402). It is assumed here that unobserved states can transition into one another, although the transitions cannot be observed directly, but rather only outputs or emissions of the modeled system. Relative to the modeling present, the unobserved states are the values of electrical variables that are actually present at the nodes, wherein in the energy distribution network only some of the nodes as measurement locations with measuring devices are configured to detect emissions or measurement values for the electrical variables.

The hidden Markov model is used to deduce a most probable value for a second electrical variable for each node. With the aid of the second electrical variable, the network state can be provided as state estimation. In this case, the network state arises directly if the voltage is used as the electrical variable. If the current intensity is output, then it is also possible to calculate the voltage at all the nodes. The hidden Markov model is used to obtain the state variables for the electrical network which correspond to the complex voltage or the complex current, on the basis of the measurement values and the distributions obtained from the training. The obtained state variables for all the network nodes of the exemplary network are the most probable set taking into account the given measurement values.

In principle, the real and imaginary parts of the complex state variable are conditionally independent, and so the two components could be traversed in parallel in the hidden Markov model. That is shown on the basis of the example of the complex voltage:

P(V^{real},V^{imag})=P(V^{real})P(V_{imag})

That likewise means that the state changes can be modeled as bivariate distributions:

$$( {S}_{t} \vert {S}_{t - 1} ) = 0.5 ( P ( {V}_{t}^{real} \vert {V}_{t - 1}^{real} ) + P ( {V}_{t}^{imag} \vert {V}_{t - 1}^{timag} ) )$$

In order to obtain a bivariate distribution for emission probabilities, the separate distributions over the real and imaginary parts are replaced by the distribution of the absolute value:

P(P|V^{real},V^{imag})=P(P|V^{mag})

P(Q|V^{real},V^{imag})=P(Q|V^{mag})

P(I|V^{real},V^{imag})=P(I|V^{mag})

P(V|V^{real},V^{imag})=P(V|V^{mag})

The same steps can be implemented for current as state variable.

The method uses a network model and a load flow application, which is often already available in control center systems and which can be used straightforwardly in this context. It furthermore expects only very rough information about the loads that is normally available in the control center systems (load distributions). The type of measurement values available is unimportant for the method, and the latter can also manage very well with measurements that have failed intermittently, since the hidden Markov model is generated online in each case.

In addition, since the method employs distributions, measurement values that are grossly erroneous are taken into account by the method to a lesser extent. On such measurements, the deviations between the estimated and measured values turn out to be larger.

The accuracy of the estimation is improved by improved observability of the network, i.e. by additional measurement locations with measuring devices. This has a positive influence on the calculation time, since additional measurement values restrict the possible state space at the nodes. Non-symmetrical networks can also be calculated using the method. In this case, it is necessary to choose currents as state variables and to calculate three hidden Markov models. This procedure is able to be parallelized very well. It is possible here e.g. to calculate the hidden Markov model for each phase on an individual processor or a separate server computer, which increases speed. The method supports loop topologies as well.

In one variant, the method is based on the use of finite hidden Markov models. It can therefore be assigned to the group of methods from the field of machine learning. In contrast to traditional state estimation methods from the field of transmission networks, the method needs only a rough specification of the load and exhibits no sensitivity in regard to the available measurement value types in the electrical network. The choice of state variables also has no influence on the solution-finding stability. There are no convergence problems. In contrast to neural networks, the method does not require training, nor does it need to store and train a separate model for each measurement value constellation and switch position. Rather, the method stores only training data, and not models.

The accuracy of the state estimation depends on how well the data preparation phase was carried out with the aid of repeated load flow calculations (the same limitation as neural networks), and on the magnitude of the inconsistencies in the SCADA measurement values (all methods equally affected). The first step is trivial, however, and can be provided by repeated implementations of load flow calculations in various loading scenarios.

The execution time for the state estimation is longer than the time that can be achieved with neural networks, but shorter than the time required to provide the analytical solution.

In one preferred embodiment of the method according to the invention, a Viterbi algorithm is used for the determination of the most probable value for the second electrical variable. In this case, the second electrical variable constitutes a state variable of the model in the sense explained initially.

This is an advantage because the most probable values of the electrical variables that were identified with the aid of the hidden Markov model can be determined in a simple manner.

The Viterbi algorithm is known for example from Wikipedia (permanent link: https://de.wikipedia.org/w/index.php?title=Viterbi-Algorithmus&oldid=213887390). The use of the hidden Markov model together with the Viterbi algorithm makes it possible to find the most probable sequence of states on the network nodes which were generated by a stochastic process which is partially observable by way of the SCADA measurement values.

In a further preferred embodiment of the method according to the invention, by using a first selection device, a subgroup of load flow results is selected from the load flow data set and provided for the state estimation device, wherein the similarity between present measurement values measured at measurement locations and the probability distributions is ascertained on the basis of a similarity measure, and the respective load flow result is selected in the event of a threshold value for the similarity being exceeded.

In a further preferred embodiment of the method according to the invention, by using a third selection device by using a first selection device, a subgroup of load flow results is selected from the load flow data set and provided for the state estimation device, wherein the load flow results are selected on the basis of one of the following temporal restrictions: time of day, type of day, season. The topology configuration of the energy network can also be taken into account.

For this purpose there are two possibilities, for example. In order to save memory space, only distributions of the state variables for each of the 96 day intervals (every 10 minutes temporal resolution), type of day (workday, weekend or holiday), season and topology are stored for each node of the network. The distributions that match the search criteria mentioned above are chosen for the calculation.

The other possibility includes storing the individual calculation results (power, reactive power, current intensity and voltage at each node), in collected form, independently of the criteria mentioned above.

This embodiment is advantageous because skillful selection of the previously simulated load flow cases enables a comparatively particularly accurate and rapid calculation of the network stayed in the hidden Markov model. The Euclidean distance, for example, can be used as the similarity measure. The subgroup includes preferably more than 5, even more preferably more than 35, load flow results. There are very particularly preferably 96 load flow results in the subgroup.

In a further preferred embodiment of the method according to the invention, by using a second selection device, load flow results whose underlying switching states correspond to the present switching states are selected from the load flow data set and provided for the state estimation device. This is an advantage because skillful selection of the previously simulated load flow cases enables a particularly accurate and rapid calculation of the network state in the hidden Markov model. The subgroup includes preferably more than 5, even more preferably more than 35, load flow results. This embodiment can preferably be combined with the aforementioned selection in accordance with a similarity measure in order to enable particularly accurate and rapid calculations of the system state.

In a further preferred embodiment of the method according to the invention, at least one of the following electrical variables is used as first electrical variable: electrical power, electrical reactive power, electrical voltage, electrical current intensity. In this case, e.g. complex numbers are used to represent voltage and electrical current intensity.

In a further preferred embodiment of the method according to the invention, at least one of the following electrical variables is used as second electrical variable: electrical voltage, electrical current intensity.

In a further preferred embodiment of the method according to the invention, a medium-voltage grid having a rated voltage of 1 kV to 52 kV is used for the electrical energy distribution network.

In a further preferred embodiment of the method according to the invention, a low-voltage grid having a rated voltage of at most 1 kV is used for the electrical energy distribution network. For low-voltage grids, too, it is now possible to provide sufficiently accurate topology information.

Against the background of known arrangements for a state estimation, the invention is furthermore faced with the object of specifying a state estimation arrangement that enables the state of an electrical energy distribution network to be estimated comparatively simply, rapidly and reliably.

With the objects of the invention in view, there is also provided a state estimation arrangement for a state estimation of an electrical energy distribution network, which comprises a load flow calculation device configured, on the basis of a network model taking into account nodes and switching devices and measurement locations, for a multiplicity of load states and for a multiplicity of switching states of the switching devices, to carry out load flow calculations and to store the respective load flow result in a load flow data set, wherein the load flow data set for each node in the network model provides a probability distribution for a respective value of at least one first electrical variable, and a state estimation device is configured to determine a state estimation that includes the respective voltage values at the nodes for the electrical energy distribution network, taking into account the load flow data set and present switching states of switching devices and present measurement values that were detected at the measurement locations, a hidden Markov model is used to determine a most probable value for a second electrical variable for each node.

Preferred embodiments are described in the dependent claims. The same advantages as explained at the outset for the method according to the invention also result analogously.

Against the background of known computer program products for a state estimation, the invention is furthermore faced with the object of specifying a computer program product that enables the state of an electrical energy distribution network to be estimated comparatively simply, rapidly and reliably.

With the objects of the invention in view, there is concomitantly provided a computer program product, comprising instructions which, when the program is executed by a computer, cause the computer to carry out the method according to the invention.

The same advantages as explained at the outset for the method according to the invention also result analogously.

Other features which are considered as characteristic for the invention are set forth in the appended claims.

Although the invention is illustrated and described herein as embodied in a method for a state estimation of an electrical energy distribution network, a state estimation arrangement and a computer program product, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a flow chart showing the method steps for data preparation;

FIG. 2 is a flow chart showing the method steps for state estimation;

FIG. 3 is a diagram of an IEEE standard test network with a series of nodes; and

FIG. 4 is an illustration of a state change of a node.

### DETAILED DESCRIPTION OF THE INVENTION

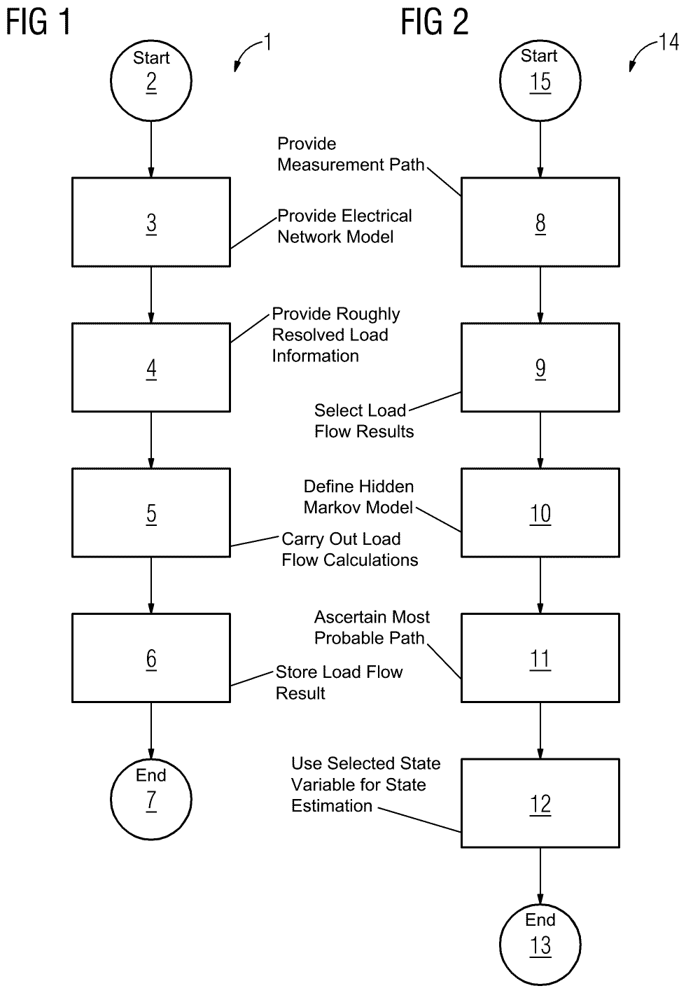

Referring now to the figures of the drawings in detail and first, particularly, to FIG. 1 thereof, there are seen method steps for data preparation. The method is formed of two steps:
data preparation 1
actual state estimation 14.

The data preparation 1 is carried out in a manner decoupled from state estimation and the results thereof are provided in a database. After the start 2, an electrical network model as a so-called bus-branch model is provided in step 3. Step 4 involves providing roughly resolved load information as a Gaussian normal distribution for each network node, i.e. what loads might be present at the individual network nodes in accordance with the network model. In step 5, load flow calculations are carried out on the basis of a network model for a multiplicity of load states and for a multiplicity of switching states of switching devices, and in step 6, the respective load flow result is stored in a load flow data set.

The load flow result can be stored either in collected fashion in the form of distributions of the electrical variables (complex current, voltage and power) for each network node, for each of the 96 day times, the day type, season or topology, etc., or as a separate result for each simulation with individual values for the abovementioned electrical variables at each node.

The load flow result can include one or more of the following values for each node, for example: current, voltage, power, reactive power. The data preparation 1 is thereby concluded in step 7.

In the case of the actual state estimation 14, after the start 15, topology information about the energy network is provided. That topology information and the equipment parameters are taken as a basis for creating a bus-branch model including measurement site information and an admittance matrix, for example.

Indications about lines and branch junctions of the network, i.e. about nodes in the energy network, are thus present. Measurement locations of measurement sites which are generally spatially assigned to a node are furthermore contained. Moreover, switching devices are taken into account in the bus-branch model. With the bus-branch model and the admittance matrix, it is possible to calculate load flows in the network.

A measurement path along which a load flow is considered is furthermore provided in step 8.

In the next step 9, load flow results having the same (or a very similar) topology are selected in the load flow data set, that is to say that in particular the switching devices have the comparable switching positions. Here, therefore, an interim result is retrieved from the data preparation 1, which can be done particularly simply and rapidly.

This involves choosing either the collected results in the form of distributions or individual results with the use of the Euclidean distance measurement. In the second case, the distributions are calculated subsequently.

Furthermore, the selected load flow result should have the most similar measurement path in comparison with the measurement path chosen in step 8.

Step 10 involves defining a hidden Markov model, based on the data from step 9, which uses either the voltage or the current intensity as state variable.

In step 11, the Viterbi algorithm is used to ascertain the most probable path along the measurement path.

Step 12 involves using the selected state variable for state estimation for the entire energy network considered. The obtained state variables and the admittance matrix are taken as a basis for calculating the other electrical variables at the nodes.

The end of the method is thus reached in step 13.

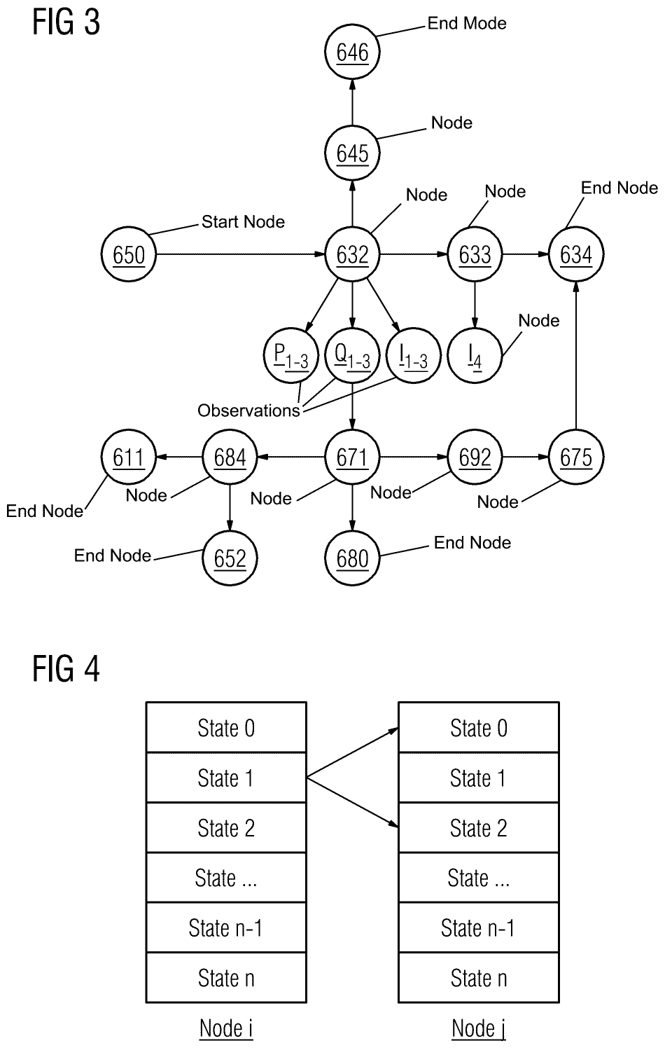

FIG. 3 shows the structure of a hidden Markov model for an IEEE test network with depicted state transitions between the nodes, start and end nodes.

Node 650 is the start node. The node 650 represents an infeed busbar of the energy network or partial network which is intended to be calculated. The nodes P₁₋₃, Q₁₋₃ and I₁₋₃ denote observations (SCADA measurements), which in principle can be positioned at any desired nodes in the network.

The nodes 646, 634, 611, 652, 680 represent “end nodes.” Once all “end nodes” have been reached, the hidden Markov model has been traversed. The arrows indicate how the graph is traversed with the nodes from the infeed to the “end nodes.”

FIG. 4 shows an illustration of a state change of a node. The state space of the state variable is discretized, and the state transitions and emission distributions are modeled by using bivariate normal distributions. The probabilities can be calculated e.g. according to the method described in the publication “Short-term load forecasting with discrete Hidden Markov Models” by S. Henselmeyer and M. Grzegorzek, 2020, Computer Science J. Intell. Fuzzy Syst.

In conclusion, the process of generating a hidden Markov model can be described as follows:
generating transition and emission distributions based on the data from the load flow data set;
discretizing the state space (i.e. identical state space for each node);
calculating an optimum path by using the Viterbi method; and
mapping the values of the state variables onto the other values from the load flow data set using distributions of the probability.

1. A method for a state estimation of an electrical energy distribution network, the method comprising:
using a load flow calculation device based on a network model taking into account nodes and switching devices and measurement locations, for a multiplicity of load states and for a multiplicity of switching states of the switching devices, to carry out load flow calculations and to store a respective load flow result in a load flow data set, the load flow data set for each node in the network model providing a probability distribution for a respective value of at least one first electrical variable;
using a state estimation device to determine a state estimation including respective voltage values at the nodes for the electrical energy distribution network; and
taking into account the load flow data set and present switching states of the switching devices and present measurement values having been detected at the measurement locations, while using a hidden Markov model to determine a most probable value for a second electrical variable for each node.

2. The method according to claim 1, which further comprises using a Viterbi algorithm for determination of the most probable value for the second electrical variable.

3. The method according to claim 1, which further comprises using a first selection device to select and provide a subgroup of load flow results from the load flow data set for the state estimation device, ascertaining a similarity between present measurement values measured at measurement locations and probability distributions based on a similarity measure, and selecting a respective load flow result upon exceeding a threshold value for the similarity.

4. The method according to claim 1, which further comprises using a first selection device to select and provide a subgroup of load flow results from the load flow data set for the state estimation device, and selecting the load flow results based on a temporal restriction selected from time of day, type of day, and season.

5. The method according to claim 4, which further comprises using a second selection device to select and provide load flow results having underlying switching states corresponding to present switching states from the load flow data set for the state estimation device.

6. The method according to claim 1, which further comprises using at least one electrical variable selected from electrical power, electrical reactive power, electrical voltage, and electrical current intensity, as a first electrical variable.

7. The method according to claim 1, which further comprises using at least one electrical variable selected from electrical voltage, and electrical current intensity, as a second electrical variable.

8. The method according to claim 1, which further comprises using a medium-voltage grid having a rated voltage of 1 kV to 52 kV for the electrical energy distribution network.

9. The method according to claim 1, which further comprises using a low-voltage grid having a rated voltage of at most 1 kV for the electrical energy distribution network.

10. A state estimation arrangement for a state estimation of an electrical energy distribution network, the state estimation arrangement comprising:
a load flow calculation device configured, based on a network model taking into account nodes and switching devices and measurement locations, for a multiplicity of load states and for a multiplicity of switching states of the switching devices, to carry out load flow calculations and to store a respective load flow result in a load flow data set, the load flow data set for each node in the network model providing a probability distribution for a respective value of at least one first electrical variable;
a state estimation device configured to determine a state estimation including respective voltage values at the nodes for the electrical energy distribution network; and
a hidden Markov model being used to determine a most probable value for a second electrical variable for each node, taking into account the load flow data set and present switching states of switching devices and present measurement values having been detected at the measurement locations.

11. The state estimation arrangement according to claim 10, wherein the state estimation device is configured to use a respective Viterbi algorithm for the determination of the most probable value for the second electrical variable.

12. The state estimation arrangement according to claim 10, which further comprises a first selection device configured to select a subgroup of load flow results from the load flow data set and to provide the subgroup of load flow results for the state estimation device, a similarity between present measurement values measured at measurement locations and probability distributions being ascertained based on a similarity measure, and a respective load flow result being selected upon exceeding a threshold value for the similarity.

13. The state estimation arrangement according to claim 12, which further comprises a second selection device configured to select load flow results having underlying switching states corresponding to present switching states from the load flow data set and to provide the load flow results for the state estimation device.

14. A non-transitory computer program product, comprising instructions which, when executed on a computer, cause the computer to carry out the method according to claim 1.
